(19) United States
(12) Patent Application Publication
(10) Pub. No.: US 2014/0327619 A1
(43) Pub. Date: Nov. 6, 2014

(54) INPUTTING APPARATUS FOR REACTING TO AN OPERATION STATE AND METHOD THEREOF

(71) Applicant: DEXIN CORPORATION, New Taipei City (TW)

(72) Inventor: YUAN-JUNG CHANG, New Taipei City (TW)

(73) Assignee: DEXIN CORPORATION, New Taipei City (TW)

(21) Appl. No.: 13/875,574

(22) Filed: May 2, 2013

(51) Int. Cl. G06F 3/0354

(52) U.S. Cl. CPC G06F 3/03543
USPC 345/163

(57) ABSTRACT

An inputting apparatus for reacting to an operation state comprises an input unit and a control unit. The input unit for input operation generates an input operation signal. The control unit is coupled to the input unit. The control unit outputs an input operation instruction to a computer apparatus based on the input operation signal, wherein the control unit analyzes the input operation signal and generates an adjustment instruction according to the analysis result, so that the inputting apparatus adjusts a first operation mode used by the present work to a second operation mode based on the adjustment instruction.

### BACKGROUND OF THE INVENTION

1. Field of the Invention

The present invention relates to an inputting apparatus and method thereof; in particular, to an inputting apparatus used for a computer apparatus and method thereof.

2. Description of Related Art

Accompanied by progress of computer technology, the life of current people is closely related to computer apparatuses. For example, people can operate a computer apparatus via a general inputting apparatus such as a mouse or a keyboard, so as to conveniently perform, for example, a web page browsing, a cross-bank account transfer, a labor insurance data query, a community web side logging or a mail message transceiving etc.

The sensitivity or the polling rate of a general inputting apparatus has been set before outgoing from factory, so as to coincide with requirements of general people. However, people can quickly operate a general inputting apparatus according to personal habit; or people can slowly operate a general inputting apparatus. Under different application programs, the operation inconvenience of a general inputting apparatus will be caused in an operation mode of same sensitivity and polling rate.

Next, elders of larger age usually operate an inputting apparatus with a slower speed, while young persons usually operate an inputting apparatus with a faster speed. Therefore, people mostly need to adjust the sensitivity of a general inputting apparatus so as to coincide with their own requirements.

### SUMMARY OF THE INVENTION

The object of the present invention is to provide an inputting apparatus for reacting to an operation state and method thereof, so as to solve the above problem.

The present invention provides an inputting apparatus for reacting to an operation state. The inputting apparatus comprises an input unit, a memory unit and a control unit. The input unit is used for input operation to generate an input operation signal. The memory unit is used for recording the input operation signal. The control unit is coupled to the input unit and the memory unit, and outputs an input operation instruction to a computer apparatus according to the input operation signal. The control unit analyzes the input operation signal and generates an adjustment instruction according to analysis result, so that the inputting apparatus adjusts a first operation mode used by the present work to a second operation mode based on the adjustment instruction.

The present invention provides a method for reacting to an operation state of an inputting apparatus. Said method comprises: generating an input operation signal according to an input operation, wherein the input operation signal lets the inputting apparatus output an input operation instruction to a computer apparatus; analyzing the input operation signal; determining whether to generate an adjustment instruction according to analysis result, wherein the adjustment instruction lets the inputting apparatus adjust a first operation mode used by the present work to a second operation mode.

A concrete means of the present invention consists in that the control unit of the inputting apparatus is used to analyze the input operation signal, and determines whether to generate an adjustment instruction according to analysis result, wherein the adjustment instruction lets the inputting apparatus adjust a first operation mode used by the present work to a second operation mode. By means of the above mechanism, the operation convenience of the inputting apparatus may be enhanced, so as to effectively solve problem such as the inconvenience of operating the inputting apparatus either for people of different ages or under different application programs.

In order to further the understanding regarding the present invention, the following embodiments are provided along with illustrations to facilitate the disclosure of the present invention. However, the description and drawings are merely provided for reference and illustration, without any intention to be used for limiting the present invention.

### BRIEF DESCRIPTION OF THE DRAWINGS

FIG. 1 shows a system architecture schematic diagram of an inputting apparatus for reacting to an operation state according to an embodiment of the present invention;

FIG. 2 shows a functional block diagram of an inputting apparatus for reacting to an operation state according to an embodiment of the present invention;

FIG. 3 shows a schematic diagram of an inputting apparatus for reacting to an operation state according to another embodiment of the present invention;

FIG. 4 shows a flow chart of a method for reacting to an operation state of an inputting apparatus according to another embodiment of the present invention;

FIG. 5 shows a flow chart of a method for reacting to an operation state of an inputting apparatus according to another embodiment of the present invention; and

FIG. 6 shows a flow chart of a method for reacting to an operation state of an inputting apparatus according to another embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objects and advantages related to the present invention will be illustrated in the subsequent descriptions and appended drawings.

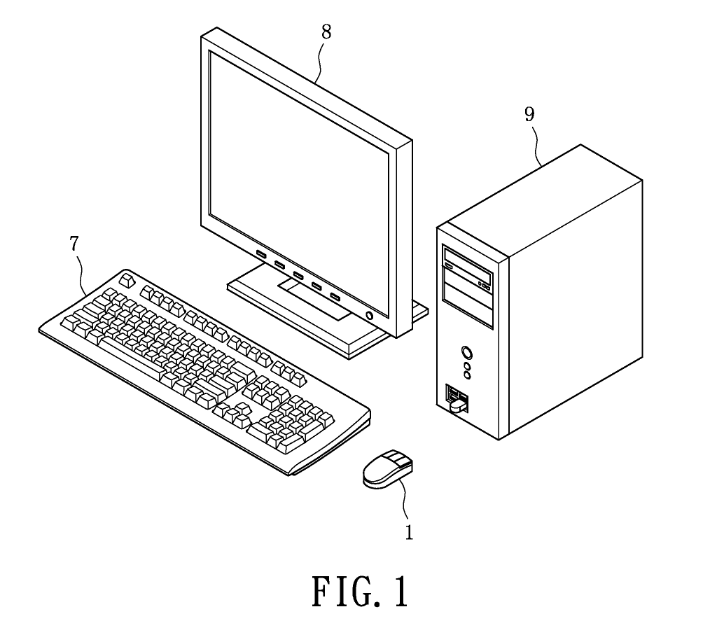

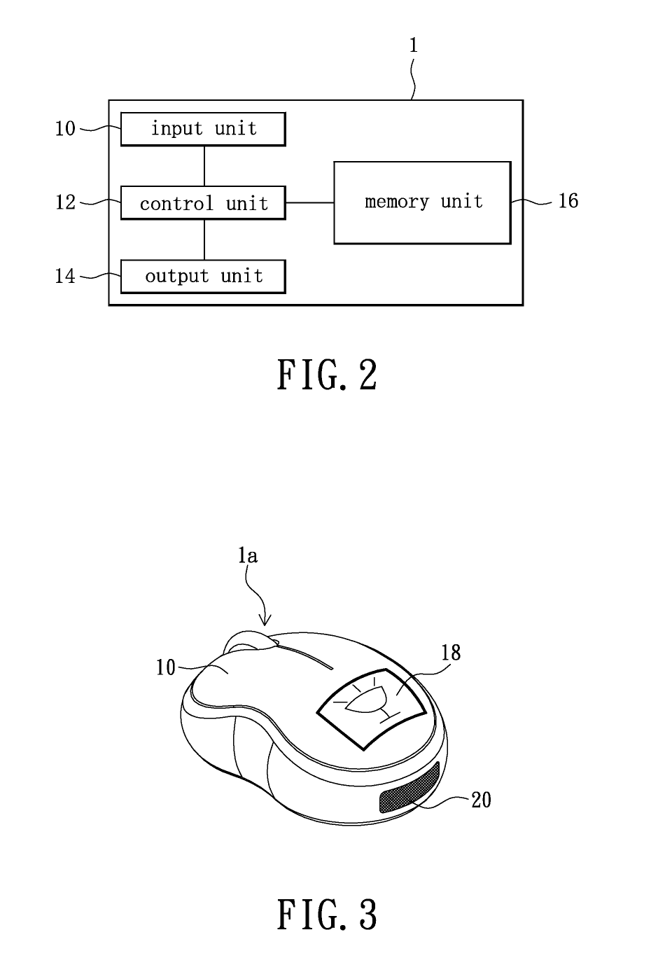

FIG. 1 shows a system architecture schematic diagram of an inputting apparatus for reacting to an operation state according to an embodiment of the present invention. FIG. 2 shows a functional block diagram of an inputting apparatus for reacting to an operation state according to an embodiment of the present invention. Please refer to FIG. 1 and FIG. 2. FIG. 1 shows a computer host 9, a display screen 8, a keyboard 7 and a mouse 1. In practice, the inputting apparatus of the present invention may be, for example, a wired keyboard, a wireless keyboard, a wired mouse or a wireless mouse used for the input of the computer host 9 or pointing to a cursor operation. In order to illustrate conveniently, the inputting apparatus in each embodiment of the present invention is illustrated by means of a mouse 1. The type of the inputting apparatus is not limited in the present embodiment.

Please refer to FIG. 2. FIG. 2 shows a mouse 1, and the mouse 1 comprises an input unit 10, a control unit 12, an output unit 14 and a memory unit 16. The input unit 10 may be, for example, at least one of a left key of a mouse, a right key of a mouse, a mouse roller and a mouse displacement sensor or a combination thereof. Of course, when the input unit 10 is pressed, rolled or moved, a corresponding input operation signal is generated and transmitted to the control unit 12, while the input operation signal may be, for example, a right key signal of a mouse, a left key signal of a mouse, a mouse roller signal or a mouse displacement signal. Those skilled in the art should know the function of the input unit 10 and thus the description thereof is omitted here.

The output unit 14 may be, for example, a radio frequency (RF) transmitter for receiving the input operation instruction transmitted by the control unit 12 and transmitting the input operation instruction to the computer host 9, wherein the input operation instruction lets the computer host 9 execute corresponding instruction. In other embodiments, the output unit 14 may be a wired transmitter. The type of the output unit 14 is not limited in the present embodiment.

The control unit 12 is coupled to the input unit 10, the output unit 14 and the memory unit 16. The control unit 12 may be, for example, a CPU or a micro-processor (MCU) etc., for executing a signal operation and processing among each unit in the mouse 1. In practice, the control unit 12 receives an input operation signal and generates an input operation instruction, wherein the control unit 12 transmits the input operation instruction via the output unit 14 to a computer apparatus.

The memory unit 16 is composed of a non-volatile memory, for example, a flash memory or an EEPROM. In practice, the memory unit 16 is used for recording the input operation signal, and the memory unit 16 stores at least one predetermined number of times, for example, the memory unit 16 stores several predetermined numbers of times. When the accumulated amount of the input operation signal attains one of the predetermined numbers of times, the control unit 12 generates an adjustment instruction. The type of the predetermined numbers of times stored in the memory unit 16 is not limited in the present embodiment.

It is worth noting that the control unit 12 can analyze an input operation signal and generates an adjustment instruction according to the analysis result, so as to let the mouse 1 adjust a first operation mode used by the present work to a second operation mode according to the adjustment instruction. In practice, that the control unit 12 analyzes the input operation signal is to analyze whether the received number of times of the input operation signal attains a predetermined number of times or not. If yes, the control unit 12 generates an adjustment instruction.

By way of example, three predetermined numbers of times are stored in the memory unit 16. For example, the three predetermined numbers of times are respectively one thousand times, five thousand times and ten thousand times of the input operation signal. When the input unit 10 is really pressed one thousand times, the control unit 12 analyzes the input operation signals of said one thousand times. For example, a user presses the input unit 10 ten times per minute, thus the analysis result of the input operation signals of said one thousand times will be generated with an average speed of about 6 second interval. Of course, the control unit 12 generates a first adjustment instruction according to analysis result, thus a first operation mode used by the present work is adjusted to a second mode.

Next, when the control unit 12 determines that the accumulated amount of the input operation signal attains a predetermined number of times, the control unit 12 generates an adjustment instruction to directly adjust the first operation mode to a second operation mode. For example, three predetermined numbers of times are stored in the memory unit 16, while the three predetermined numbers of times are respectively one thousand times, five thousand times and ten thousand times of the input operation signal. When the input unit 10 is really pressed one thousand times, the control unit 12 generates a first adjustment instruction, so as to let the mouse 1 directly be adjusted to the second operation mode. When the input unit 10 is really pressed five thousand times or ten thousand times, the control unit 12 generates a second or a third adjustment instruction, so as to let the mouse 1 directly be adjusted to a third or a fourth operation mode.

In other embodiments, that the control unit 12 analyzes the input operation signal is to determine within a predetermined period whether the received number of times of the input operation signal attains a predetermined number of times or not. If yes, the control unit 12 generates an adjustment instruction. In practice, the predetermined period may be, for example, ten hours, one day, one week or one month etc., and can be freely designed by those skilled in the art according to requirement. Similarly, when the control unit 12 determines within a predetermined period that the accumulated number of times of the input operation signal attains a predetermined number of times, the control unit 12 generates an adjustment instruction to directly adjust the first operation mode to the second operation mode. The types of the predetermined period and the predetermined numbers of times are not limited in the present embodiment.

For example, the first operation mode means that the input operation instruction is outputted with a first polling rate, while the second operation mode means that the input operation instruction is outputted with a second polling rate, wherein the first polling rate may be larger than, smaller than or not equal to the second polling rate. In practice, the polling rate is, for example, a rate with which the mouse 1 transmits the input operation instruction to a computer apparatus when the input unit 10 of the mouse 1 is pressed.

By way of example, the first polling rate of a mouse 1 ranked among general users is 125 Hertz. When a user operates a mouse 1 to perform an electronic contest game and the property of the input operation signal of said one thousand times is analyzed to belong to a player of electronic contest type, the control unit 12 will generate an adjustment instruction according to analysis result, thus the first operation mode of the mouse 1 is adjusted to the second operation mode, while the second operation mode means a second polling rate ranked among players of electronic contest type. The second polling rate may be, for example, 250 Hertz. The numerals and types of the first and the second polling rate are not limited in the present embodiment.

As can be known similarly, when the input unit 10 is really pressed five thousand times or ten thousand times, the control unit 12 analyzes the input operation signal of said five thousand times or ten thousand times. For example, a user usually presses the input unit 10 twenty times or thirty times per minute, then the control unit 12 generates a second or a third adjustment instruction, thereby the second operation mode used by the present work will be adjusted to the third operation mode; or the third operation mode used by the present work will be adjusted to a fourth operation mode.

The first, the second, the third or the fourth operation mode in the present embodiment means that the input operation instruction is outputted respectively with a first, a second, a third or a fourth polling rate. In other embodiments, the first, the second, the third or the fourth operation mode means that the reactive speed of the inputting apparatus is respectively a first, a second, a third, or a fourth speed. The first, the second, the third, or the fourth speed may be, for example, the sensitivity of the mouse 1, for example, “a pointing cursor generates an average moving distance according to the movement of the displacement sensor of a mouse”, “a browsed web page generates an average scrolling distance according to the rolling of a mouse roller”, or “a pointing cursor generates an average moving angle according to the moving angle of the displacement sensor of a mouse”. The type of the first, the second, the third or the fourth operation mode is not limited in the present embodiment.

When a user initially uses a mouse 1, the user is unfamiliar with the sensitivity of the mouse 1, and an error clicking action of a pointing cursor is usually caused, whereas the mouse 1 can set some parameters such as initial polling rate and sensitivity based on unfamiliar operation of the mouse used for the user. When the user really operates a mouse 1 to attain a predetermined number of times, the mouse 1 will generate an adjustment instruction and adjusts the operation mode according to inertia with which the user operates the mouse 1. Thus, the user becomes more familiar with the mouse 1, and then the mouse 1 will become more suitable for the requirement of the user.

For example, a user rolls the roller of a mouse, and the scrolling distance on screen 8 is adjusted according to the inertia of the user; or the user moves the mouse 1, and the moving distance of a pointing cursor is adjusted according to the inertia of the user; or the user presses a right key and a left key of a mouse with a frequency, and the polling rate of an input operation instruction is adjusted according to the inertia of the user.

It is worth mentioning that, in other embodiments, the control unit 12 determines within a predetermined period whether the received number of times of the input operation signal attains a predetermined number of times, if yes, the control unit 12 generates the adjustment instruction. In practice, the control unit 12 can analyze the input operation signal by determining whether the input operation signal is a trigger signal. If the input operation signal is determined as a trigger signal, the control signal is triggered to analyze a subsequent input operation signal within a predetermined period, so as to generate an adjustment instruction.

In practice, the mouse 1 has a timer unit (not shown), and the timer unit (not shown) is coupled to the control unit 12. For example, the trigger signal is set to be generated by pressing the roller of a mouse 1 for 5 seconds. When the control unit 12 determines that the input operation signal is a trigger signal, the control unit 12 is activated within a predetermined period to analyze a subsequent input operation signal, so as to let the control unit 12 generate an adjustment instruction. In this manner, a user can begin to analyze the subsequent input operation signal by means of a trigger signal at any time, so as to adjust the operation mode of the mouse 1. The type of the trigger signal is not limited in the present embodiment.

By way of another example, when elders of larger age operate the mouse 1 with a slower speed so as to perform a text processing, for example, after the times of clicking a left key or a right key of a mouse exceed one thousand times, the control unit 12 can analyze the input operation signals of said one thousand times. Of course, the operation frequency and clicking speed of the input operation signals of said one thousand times is relatively slow, thereby an adjustment instruction is generated, so that the operation mode of the mouse 1 is adjusted to a rank that is suitable for an elder of larger age, for example, the polling rate of the mouse 1 is 75 Hertz. Those skilled in the art may perform a free design according to requirement, thus the description thereof is omitted here.

It is worth mentioning that the adjustment instruction may be an instruction for at least one of a left key sensitivity of a mouse, a right key sensitivity of a mouse, a mouse roller sensitivity, a mouse displacement sensitivity and a polling rate or a combination thereof. For example, when the adjustment instruction is an instruction for a left key sensitivity of a mouse, and the left key of the mouse is pressed, then the polling rate with which an input operation instruction is generated to be given to a computer apparatus will be changed, so as to coincide with a user's requirement, while the others such as a mouse right key, a mouse roller or a mouse displacement sensor will maintain initial setting parameter. The type of the adjustment instruction is not limited in the present embodiment.

Based on the above, concrete means of the present invention consists in that the control unit 12 of the inputting apparatus is used for analyzing the input operation signal, and whether an adjustment instruction is generated is determined according to analysis result, wherein the adjustment instruction adjusts a first operation mode used by the present work of the inputting apparatus to a second operation mode. By means of the above mechanism, the operation convenience of the inputting apparatus may be enhanced, so as to effectively solve problem such as the inconvenience of operating the inputting apparatus either for people of different ages or under different application programs.

FIG. 3 shows a schematic diagram of an inputting apparatus for reacting to an operation state according to another embodiment of the present invention. Please refer to FIG. 3. The difference of mouse 1, 1a in FIG. 2 and FIG. 3 consists in that the mouse 1a further includes a display unit 18 coupled to a control unit 12. The control unit 12 generates an adjustment instruction, so as to let the display unit 18 output a display signal.

In practice, the display unit 18 may be, for example, a liquid crystal screen, a light emitting diode or a luminous lamp set. When the mouse 1a adjusts the operation mode, the mouse 1a displays a display signal such as prize cup, treasure, marquee, text or pattern etc. by means of the display unit 18, thereby the funny property of the mouse 1a is enhanced. In addition, the mouse 1a may download, for example, prize cup, treasure, marquee, text or pattern etc. by means of a website certification mechanism. Of course, the mouse 1a displays a display signal by means of the display unit 18. The type of the display unit 18 is not limited in the present embodiment.

In addition, the mouse 1a further includes a sound unit 20 coupled to the control unit 12. The control unit 12 generates an adjustment instruction, so as to let the sound unit 20 output a sound signal. In practice, the sound unit 20 may be a speaker or a horn. When the mouse 1a adjusts the operation mode, the mouse 1a outputs a sound signal such as cheerful sound, music or complimentary language etc. by means of the sound unit 20, thereby the funny property of the mouse 1a is enhanced. The type of the sound unit 20 is not limited in the present embodiment.

It is worth mentioning that, in other embodiments, the inputting apparatus may be, for example, a transparent keyboard or a transparent mouse. When the inputting apparatus adjusts the operation mode, the inputting apparatuses of different colors are displayed by means of the display unit 18 such as a light emitting diode. For example, a transparent keyboard or a transparent mouse shows lights of different colors such as red light, green light or blue light etc., wherein green light represents an operation mode of rank 1, blue light represents an operation mode of rank 2, and red light represents an operation mode of rank 3. The type of the inputting apparatus is not limited in the present embodiment.

In addition to the above difference, those skilled in the art should easily infer other differences by referring to the above embodiments and difference, therefore the description thereof is omitted here.

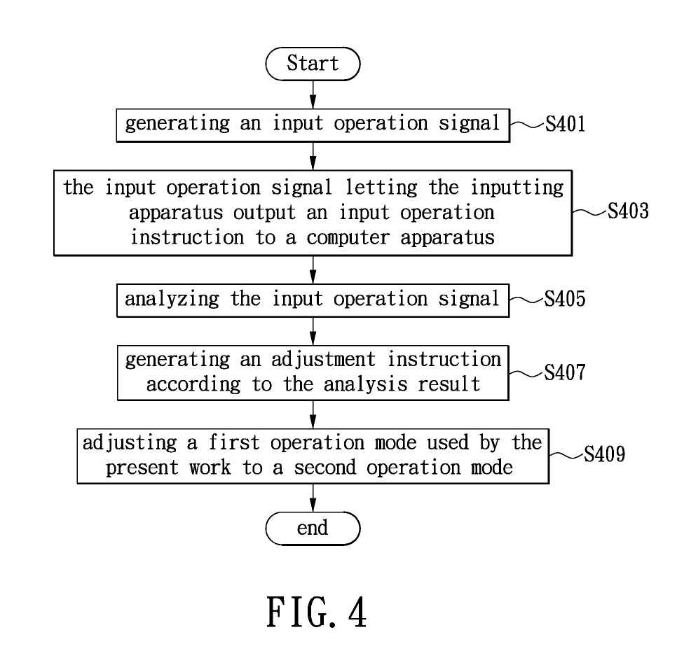

From several embodiments above, a method for reacting to an operation state of an inputting apparatus can be induced. FIG. 4. shows a flow chart of a method for reacting to an operation state of an inputting apparatus according to another embodiment of the present invention. Please refer to FIG. 4. The method for reacting to an operation state of an inputting apparatus comprises the following steps:

At first, in step S401, an input operation signal is generated. In practice, a user operates a mouse. For example, the user operates at least one of a left key of a mouse, a right key of a mouse, a mouse roller and a mouse displacement sensor or a combination thereof, thereby the mouse generates an input operation signal.

Next, in step S403, the input operation signal lets the inputting apparatus output an input operation instruction to a computer apparatus. By way of example, the pointing cursor of the mouse is located on a computer screen, and a user presses the right key of the mouse, thereby the mouse generates an input operation instruction of selection menu to a computer apparatus; or the pointing cursor of the mouse is located on a computer screen, and a user presses the left key of the mouse, thereby the mouse generates an input operation instruction of recognizing a selection to a computer apparatus. Those skilled in the art should know the function of a mouse, hence the function will not be described here.

In step S405, the input operation signal is analyzed. In practice, a user operates a mouse. If the input unit of the mouse is pressed quite frequently, an input operation signal will be generated quite frequently. In other words, the separation time between any two input operation signals will be shortened. Therefore, the control unit can analyze the input operation signals, thereby the polling rate is increased to coincide with the requirement of a user.

On the contrary, if the input unit of a mouse is not frequently pressed, the separation time between any two input operation signals will be lengthened. Therefore, the control unit can analyze the input operation signals, thereby the polling rate is decreased to coincide with the requirement of a user.

Next, in step S407, an adjustment instruction is generated according to analysis result. To describe in detail, the control unit analyzes the input operation signal, for example, when the separation time between any two input operation signals is relatively short, the control unit generates an adjustment instruction used for increasing the polling rate according to analysis result, so as to coincide with the requirement of a user.

On the contrary, the control unit analyzes the input operation signal, for example, when the separation time between any two input operation signals is relatively long, the control unit generates an adjustment instruction used for decreasing the polling rate according to analysis result, so as to coincide with the requirement of a user. The mechanism and type of the control unit to generate the adjustment instruction are not limited in the present embodiment.

In step S409, a first operation mode used by the present work of the inputting apparatus is adjusted to a second operation mode. In practice, the control unit generates an adjustment instruction, thereby the operation mode of a mouse is changed. Of course, each parameter of the operation mode of a mouse is changed according to the adjustment instruction.

By way of example, the first polling rate of the first operation mode is 125 Hertz. In other words, the mouse transmits an input operation instruction to a computer apparatus at interval of 8 micro-seconds. When a user operates a mouse frequently, the control unit analyzes the input operation signal. The control unit generates an adjustment instruction according to analysis result, so as to let the first operation mode be adjusted to the second operation mode. The second polling rate of the second operation mode is 250 Hertz. In other words, the mouse transmits an input operation instruction to a computer apparatus at interval of 4 micro-seconds, thereby the polling rate is increased to coincide with the requirement of a user.

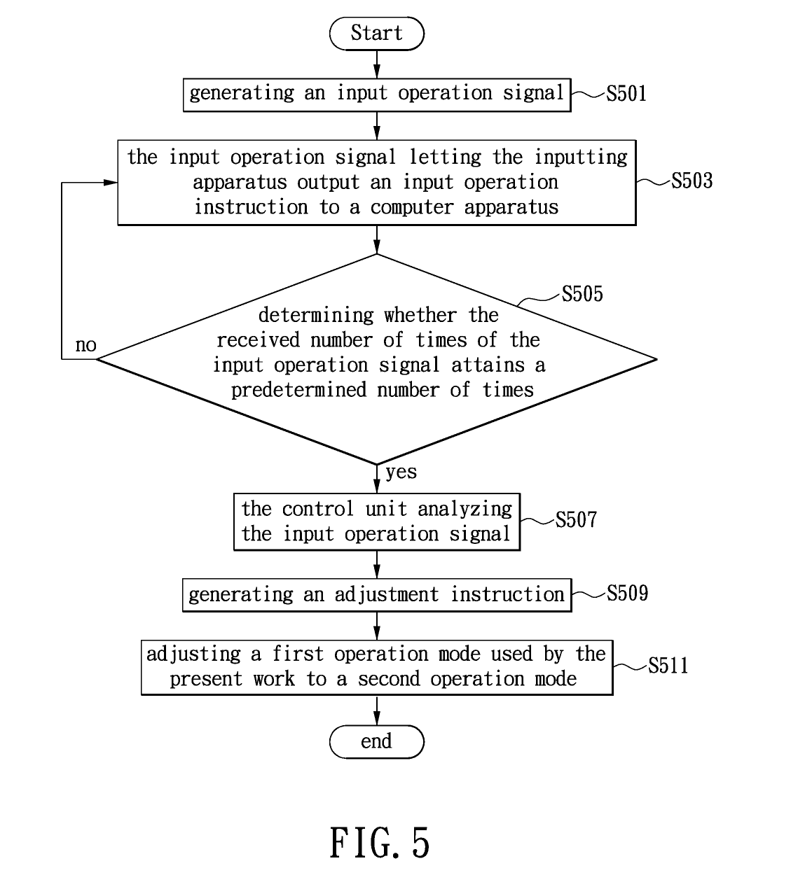

Here, another method for reacting to an operation state of an inputting apparatus is proposed, as shown in FIG. 5. FIG. 5 shows a flow chart of a method for reacting to an operation state of an inputting apparatus according to another embodiment of the present invention. Please refer to FIG. 5, based on same principle, the method for reacting to an operation state of an inputting apparatus in the present embodiment is similar to that of the above embodiment. For example, the method for reacting to an operation state of an inputting apparatus can generate an adjustment instruction according to analysis result, so that a first operation mode used by the present work of the inputting apparatus is adjusted to a second operation mode.

However, the difference between the methods of the present embodiment and the above embodiment still exists, wherein the method for reacting to an operation state of an inputting apparatus in the present embodiment comprises: in step S501, an input operation signal is generated; a user operates a mouse, so as to generate an input operation signal by means of the mouse; next, in step S503, the input operation signal lets the inputting apparatus output an input operation instruction to a computer apparatus. Furthermore, in step S505, it is determined whether the accumulated amount of the input operation signals attains at least one predetermined number of times of a memory unit. If yes, in step S507 the control unit analyzes the accumulated input operation signal.

To describe in detail, the memory unit can store internally one or several predetermined number(s) of times, while the predetermined number of times represents, for example, an accumulated value of experience for operating a mouse, for example, the input unit of a mouse is pressed ten thousand times. When a user operates a mouse ten thousand times, the control unit can analyze the accumulated input operation signals, wherein the accumulated input operation signals are, for example, data having time and frequency etc. of trigger clicking, thereby the control unit analyzes the accumulated input operation signals.

It is worth mentioning that, in other embodiments, “the control unit analyzes the input operation signal” in step S507 can also be “determining within a predetermined period whether the received number of times of the input operation signal attains a predetermined number of times”. If yes, the control unit generates an adjustment instruction, so that the inputting apparatus is adjusted to a second operation mode; if the decision result is no, the control unit outputs the input operation instruction to a computer apparatus. The type of analyzing the input operation signal within a predetermined period by means of the control unit is not limited in the present embodiment.

Next, in step S509, the control unit generates an adjustment instruction. In step S511, the first operation mode used by the present work is adjusted to a second operation mode.

In addition to the above difference, those skilled in the art should easily infer other differences by referring to the above embodiments and difference, therefore the description thereof is omitted here.

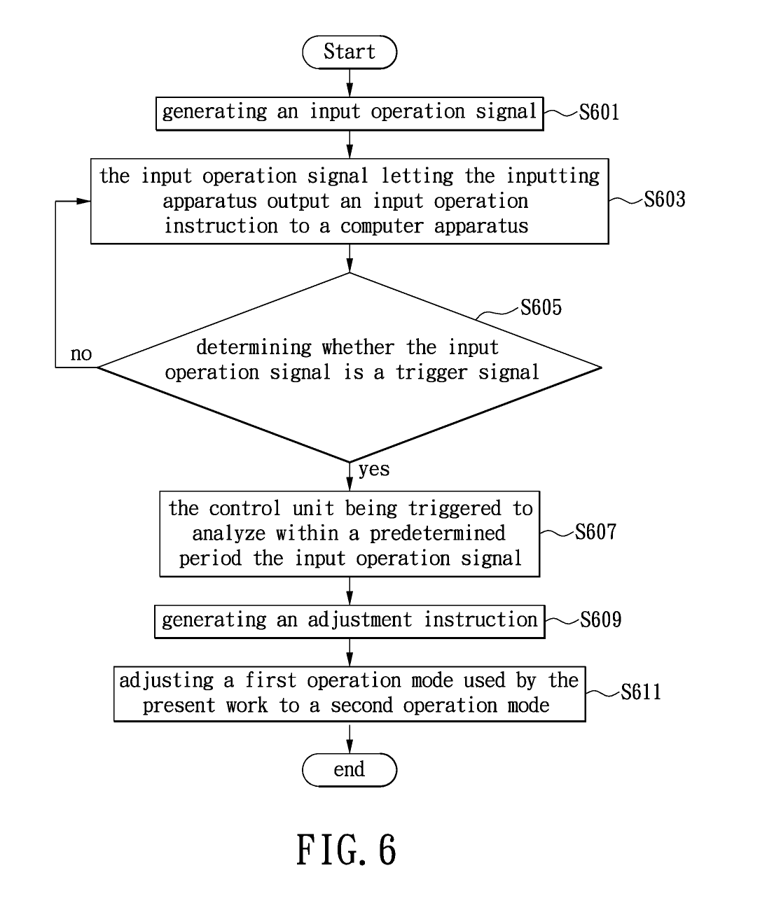

Here, another method for reacting to an operation state of an inputting apparatus is proposed, as shown in FIG. 6. FIG. 6 shows a flow chart of a method for reacting to an operation state of an inputting apparatus according to another embodiment of the present invention. Please refer to FIG. 6, based on same principle, the method for reacting to an operation state of an inputting apparatus in the present embodiment is similar to that of the above embodiment. For example, the method for reacting to an operation state of an inputting apparatus also generates an adjustment instruction according to analysis result, so that a first operation mode used by the present work of the inputting apparatus is adjusted to a second operation mode.

However, the difference between the methods of the present embodiment and the above embodiment still exists, wherein the method for reacting to an operation state of an inputting apparatus in the present embodiment comprises: in step S601, an input operation signal is generated. A user operates a mouse, so as to generate an input operation signal by means of the mouse; next, in step S603, the input operation signal lets the inputting apparatus output an input operation instruction to a computer apparatus. Furthermore, in step S605, it is determined whether the input operation signal is a trigger signal. If yes, in step S607 the control unit is triggered to analyze within a predetermined period the subsequent input operation signal.

To describe in detail, the inputting apparatus has an activating mechanism for a trigger signal. For example, a user presses a mouse right key for 5 seconds, thereby the inputting apparatus determines that the input operation signal is a trigger signal. In other embodiments, the activating mechanism for a trigger signal can be realized by pressing a setting key (not shown) or pressing the right key and the left key of a mouse simultaneously. The type of the activating mechanism for a trigger signal is not limited in the present embodiment.

Next, the control unit is triggered to analyze within a predetermined period a subsequent input operation signal. In practice, within ten minutes after the control unit is triggered, when a user operates a mouse within said ten minutes to play a computer game, the mouse will analyze the input operation signal within said ten minutes. For example, a user operates a mouse with a pressing speed of high frequency, and then the control unit analyzes the subsequent input operation signal, so as to adjust the operation mode of the mouse to coincide with the speed of the computer game.

Next, in step S609, the control unit generates an adjustment instruction. In step S611, the first operation mode used by the present work is adjusted to a second operation mode.

In addition to the above difference, those skilled in the art should easily infer other differences by referring to the above embodiments and difference, therefore the description thereof is omitted here.

Summing up the above, a concrete means of the present invention consists in that the control unit of the inputting apparatus is used to analyze the input operation signal, and determines whether to generate an adjustment instruction according to analysis result, wherein the adjustment instruction lets the inputting apparatus adjust a first operation mode used by the present work to a second operation mode. By means of the above mechanism, the operation convenience of the inputting apparatus may be enhanced, so as to effectively solve problems such as the inconvenience of operating the inputting apparatus either for people of different ages or under different application programs.

The descriptions illustrated supra set forth simply the preferred embodiments of the present invention; however, the characteristics of the present invention are by no means restricted thereto. All changes, alterations, or modifications conveniently considered by those skilled in the art are deemed to be encompassed within the scope of the present invention delineated by the following claims.

What is claimed is:

1. An inputting apparatus for reacting to an operation state, comprising:
an input unit, used for input operation to generate an input operation signal; and
a control unit, coupled to the input unit and outputting an input operation instruction to a computer apparatus according to the input operation signal;
wherein the control unit analyzes the input operation signal and generates an adjustment instruction according to analysis result, so that the inputting apparatus adjusts a first operation mode used by the present work to a second operation mode based on the adjustment instruction.

2. The inputting apparatus according to claim 1, wherein that the control unit analyzes the input operation signal is to determine within a predetermined period whether the received number of times of the input operation signal attains a predetermined number of times or not, if yes, the control unit generates the adjustment instruction.

3. The inputting apparatus according to claim 1, wherein that the control unit analyzes the input operation signal is to analyze whether the received number of times of the input operation signal attains a predetermined number of times or not, if yes, the control unit generates the adjustment instruction.

4. The inputting apparatus according to claim 1, wherein the input operation signal received by the control unit is a trigger signal, and the control unit determines within a predetermined period whether the received number of times of the input operation signal attains a predetermined number of times or not, if yes, the control unit generates the adjustment instruction.

5. The inputting apparatus according to claim 1, further comprising a display unit coupled to the control unit, wherein the control unit controls the display unit to output a display signal when the adjustment instruction is generated.

6. The inputting apparatus according to claim 1, further comprising a sound unit coupled to the control unit, wherein the control unit controls the sound unit to output a sound signal when the adjustment instruction is generated.

7. The inputting apparatus according to claim 1, wherein the first operation mode means that the input operation instruction is outputted with a first polling rate, while the second operation mode means that the input operation instruction is outputted with a second polling rate, wherein the first polling rate is not equal to the second polling rate.

8. The inputting apparatus according to claim 1, wherein the first operation mode means that a reactive speed of the inputting apparatus is a first speed, while the second operation mode means that the reactive speed of the inputting apparatus is a second speed, wherein the first speed is not equal to the second speed.

9. A method for reacting to an operation state of an inputting apparatus, comprising:
generating an input operation signal according to an input operation, wherein the input operation signal lets the inputting apparatus output an input operation instruction to a computer apparatus;
analyzing the input operation signal by means of a control unit;
determining whether to generate an adjustment instruction according to analysis result, wherein the adjustment instruction lets the inputting apparatus adjust a first operation mode used by the present work to a second operation mode.

10. The method for reacting to an operation state of an inputting apparatus according to claim 9, wherein analyzing the input operation signal is to determine within a predetermined period whether the received number of times of the input operation signal attains a predetermined number of times or not, if yes, the control unit generates the adjustment instruction.

11. The method for reacting to an operation state of an inputting apparatus according to claim 9, wherein analyzing the input operation signal is to analyze whether the received number of times of the input operation signal attains a predetermined number of times or not, if yes, the control unit generates the adjustment instruction.

12. The method for reacting to an operation state of an inputting apparatus according to claim 9, wherein analyzing the input operation signal means that, when the input operation signal received is a trigger signal, the control unit determines within a predetermined period whether the received number of times of the input operation signal attains a predetermined number of times or not, if yes, the control unit generates the adjustment instruction.

13. The method for reacting to an operation state of an inputting apparatus according to claim 9, wherein a sound signal is outputted after the adjustment instruction is generated.

14. The method for reacting to an operation state of an inputting apparatus according to claim 9, wherein a display signal is outputted after the adjustment instruction is generated.

15. The method for reacting to an operation state of an inputting apparatus according to claim 9, wherein the first operation mode means that the input operation instruction is outputted with a first polling rate, while the second operation mode means that the input operation instruction is outputted with a second polling rate, wherein the first polling rate is not equal to the second polling rate.

16. The method for reacting to an operation state of an inputting apparatus according to claim 9, wherein the first operation mode means that a reactive speed of the inputting apparatus is a first speed, while the second operation mode means that the reactive speed of the inputting apparatus is a second speed, wherein the first speed is not equal to the second speed.
